(19) United States
(12) Patent Application Publication
(10) Pub. No.: US 2021/0026349 A1
(43) Pub. Date: Jan. 28, 2021

(54) VEHICLE CONTROL SYSTEM AND VEHICLE CONTROL METHOD

(71) Applicant: TOYOTA JIDOSHA KABUSHIKI KAISHA, Toyota-shi (JP)

(72) Inventors: Yuki ITO, Iwakura-shi (JP); Tsukasa NAKANISHI, Nagoya-shi (JP); Yuta MORIKAWA, Miyoshi-shi (JP); Naoki YAMAMURO, Nagoya-shi (JP); Yuki TATSUMOTO, Nagoya-shi (JP)

(73) Assignee: TOYOTA JIDOSHA KABUSHIKI KAISHA, Toyota-shi (JP)

(21) Appl. No.: 16/897,664

(22) Filed: Jun. 10, 2020

(30) Foreign Application Priority Data
Jul. 23, 2019 (JP) 2019-135243

(51) Int. Cl. G05D 1/00; H04L 29/08; G07C 5/00

(52) U.S. Cl. CPC G05D 1/0027; G07C 5/008; H04L 67/12

(57) ABSTRACT

A vehicle selection server is configured to refer to a memory, which stores vehicle information representing each of a plurality of vehicles, and to transmit the vehicle information regarding each of the plurality of vehicles to a remote operation terminal. The remote operation terminal is configured to display the vehicle information regarding each of the plurality of vehicles on a display section, to acquire selection information, input by a remote operator, for one of the plurality of vehicles, and to transmit the selection information to the vehicle selection server. The vehicle selection server is configured to transmit identification information regarding the remote operation terminal to a vehicle control device. The vehicle control device is configured to perform control in response to vehicle operation information transmitted from the remote operation terminal corresponding to the identification information so as to cause the host vehicle to travel in the remote driving mode.

### CROSS-REFERENCE TO RELATED APPLICATION

This application is based on and claims priority under 35 USC 119 from Japanese Patent Application No. 2019-135243 filed on Jul. 23, 2019, the disclosure of which is incorporated by reference herein.

### BACKGROUND

### Technical Field

The technology disclosed herein relates to a vehicle control system and a vehicle control method.

### Related Art

The disclosure of U.S. Pat. No. 9,964,948 discloses a system for controlling a vehicle remotely.

Were vehicles that travel under remote operation such as that disclosed in the specification of U.S. Pat. No. 9,964,948 (such vehicles are referred to hereafter as “vehicles that travel in a remote driving mode”) to become widespread, it is envisaged that the number of remote operators remotely operating such vehicles would increase.

In such a situation, it is envisaged that remote operators would wish to select which vehicles to remotely operate.

However, the specification of U.S. Pat. No. 9,964,948 only discloses remote control of a self-traveling vehicle, and does not consider vehicle selection of a remote operation target vehicle by remote operator. Accordingly, were the technology disclosed in U.S. Pat. No. 9,964,948 to be employed, a remote operator would not be able to select a remote operation target vehicle as a vehicle the remote operator causes to travel in the remote driving mode.

### SUMMARY

A vehicle control system according to a first aspect includes a vehicle selection server comprising; a first memory, and a first processor coupled to the first memory; a vehicle control device comprising; a second memory, and a second processor coupled to the second memory, the second processor being configured to: control a host vehicle capable of traveling in an autonomous self-driving mode, a remote driving mode, and a manual driving mode; and a remote operation terminal comprising; a third memory, and a third processor coupled to the third memory, the third processor being configured to: operate the host vehicle remotely, wherein the first processor is configured to refer to the first memory, which stores vehicle information representing each of a plurality of vehicles, and to transmit the vehicle information regarding each of the plurality of vehicles to the third processor; wherein the third processor is configured to display the vehicle information regarding each of the plurality of vehicles on a display section, to acquire selection information, input by a remote operator, for one of the plurality of vehicles, and to transmit the selection information to the first processor; wherein the first processor is configured to transmit identification information regarding the third processor that output the selection information to the second processor of the one of the plurality of vehicles corresponding to the selection information; and wherein the second processor is configured to perform control in response to vehicle operation information transmitted from the third processor corresponding to the identification information so as to cause the host vehicle to travel in the remote driving mode.

A vehicle control method according to a second aspect is a vehicle control method for a vehicle control system including: a vehicle selection server comprising; a first memory, and a first processor coupled to the first memory; a vehicle control device comprising; a second memory, and a second processor coupled to the second memory, the second processor being configured to: control a host vehicle capable of traveling in an autonomous self-driving mode, a remote driving mode, and a manual driving mode; and a remote operation terminal comprising; a third memory, and a third processor coupled to the third memory, the third processor being configured to: operate the host vehicle remotely, wherein the method comprises: the first processor referring to the first memory, which stores vehicle information representing each of a plurality of vehicles, and transmitting the vehicle information regarding each of the plurality of vehicles to the third processor, the third processor displaying the vehicle information regarding each of the plurality of vehicles on a display section, to acquire selection information, input by a remote operator, for one of the plurality of vehicles, and transmitting the selection information to the first processor, the first processor transmitting identification information regarding the third processor that output the selection information to the second processor of the one of the plurality of vehicles corresponding to the selection information, and the second processor performing control in response to vehicle operation information transmitted from the third processor corresponding to the identification information so as to cause the host vehicle to travel in the remote driving mode.

### BRIEF DESCRIPTION OF DRAWINGS

FIG. 1 is an explanatory diagram outlining an exemplary embodiment;

FIG. 2 is a schematic block diagram illustrating a vehicle control system according to the exemplary embodiment;

FIG. 3 is an explanatory diagram to explain an example of vehicle information;

FIG. 4 is a diagram illustrating an example of configuration of a computer corresponding to respective devices configuring a vehicle control system;

FIG. 5 is a diagram illustrating an example of a sequence executed by a vehicle control system according to the exemplary embodiment; and

FIG. 6 is a diagram illustrating an example of a sequence executed by a vehicle control system according to the exemplary embodiment.

### DETAILED DESCRIPTION

Exemplary Embodiment

Explanation follows regarding an exemplary embodiment of a vehicle control system, with reference to the drawings.

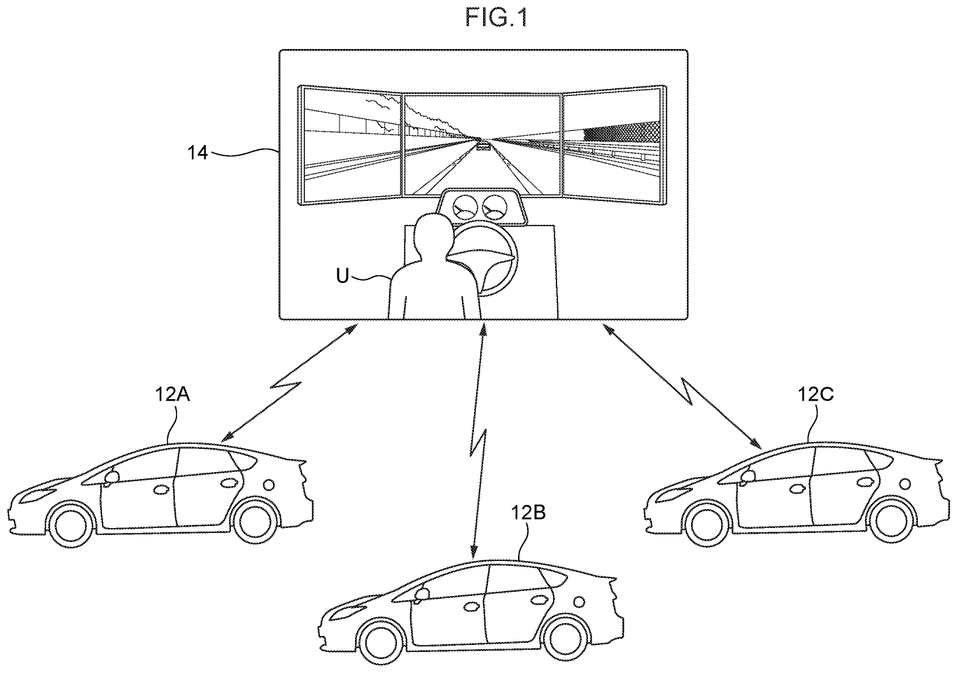

FIG. 1 is an explanatory diagram outlining the present exemplary embodiment. FIG. 1 envisages a situation in which vehicles 12A, 12B, 12C each plan to travel in a remote driving mode. In such a case, as illustrated in FIG. 1, a remote operator U at a remote operation terminal 14 remotely operates one vehicle out of the plural vehicles 12A, 12B, 12C.

When this occurs, it is envisaged that the remote operator U wishes to select which vehicle to remotely operate themselves. For example, the remote operator U may wish to remotely operate a vehicle of the same type as a vehicle for which they usually perform remote operation on an everyday basis. Alternatively, for example, the remote operator U may wish to remotely operate a vehicle on a travel route for which they usually perform remote operation on an everyday basis. Alternatively, for example, the remote operator U may wish to remotely operate a vehicle on a travel route for which they think the remote operation will be simple (such as an expressway).

In the vehicle control system of the present exemplary embodiment, the remote operator U operating the remote operation terminal selects a remote operation target vehicle. This enables the remote operator U to perform remote operation of their desired vehicle.

Specific explanation follows regarding this.

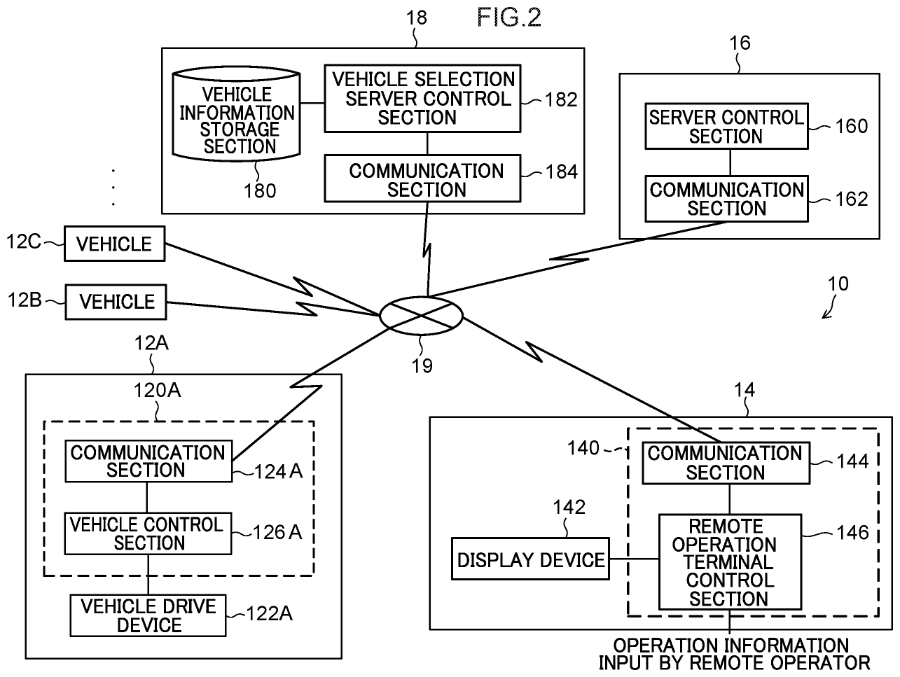

FIG. 2 is a block diagram illustrating an example of configuration of a vehicle control system 10 according to the present exemplary embodiment. As illustrated in FIG. 2, the vehicle control system 10 includes the plural vehicles 12A, 12B, 12C, . . . , the remote operation terminal 14, a server 16, and a vehicle selection server 18. The plural vehicles 12A, 12B, 12C, . . . , the remote operation terminal 14, the server 16, and the vehicle selection server 18 are connected together through a predetermined communication network 19. Note that although only the vehicles 12A, 12B, 12C are illustrated as the plural vehicles in FIG. 2, in reality more vehicles would be present. Likewise, although only the remote operation terminal 14 is illustrated as a remote operation terminal in FIG. 2, in reality more remote operation terminals would be present.

Vehicle

The vehicle of the present exemplary embodiment is a vehicle capable of traveling in an independent autonomous driving mode, the remote driving mode, and a manual driving mode. The independent autonomous driving mode is a driving mode in which the vehicle travels independently based on information successively detected by various sensors provided to the vehicle. The remote driving mode is a driving mode in which the vehicle travels based on operation information output from the remote operation terminal. The manual driving mode is a driving mode in which the vehicle travels by being driven by an occupant on board the vehicle. Note that the driving modes represent types of travel control of the vehicle.

Since the vehicle 12A and the other vehicles 12B, 12C are configured similarly to each other, explanation follows regarding configuration of the vehicle 12A only.

The vehicle 12A includes an electronic control unit (ECU) 120A that controls vehicle travel, and a vehicle drive device 122A that drives the vehicle in response to control signals from the ECU 120A. The ECU 120A is an example of a vehicle control device of the present disclosure.

As illustrated in FIG. 2, functionality of the ECU 120A includes a communication section 124A and a vehicle control section 126A.

The communication section 124A exchanges information with other devices.

The vehicle control section 126A acquires operation information transmitted from any remote operation terminal out of plural remote operation terminals through the server 16. The operation information transmitted from the remote operation terminal is operation information input to the remote operation terminal by the remote operator U.

The vehicle control section 126A also acquires operation information input by the occupant on board the vehicle. The vehicle control section 126A also acquires information relating to independent travel. For example, information relating to independent travel includes control signals from other ECUs, or sensor signals from various sensors (image sensors, laser radar sensors, or the like) installed in the vehicle.

The vehicle control section 126A controls driving of the vehicle drive device 122A based on various externally input information. For example, the vehicle control section 126A switches between the independent autonomous driving mode, the remote driving mode, and the manual driving mode based on various acquired information.

Remote Operation Terminal

As illustrated in FIG. 2, functionality of the remote operation terminal 14 includes a computer 140 provided with a communication section 144 and a remote operation terminal control section 146, and a display device 142. The display device 142 is an example of a display section of the technology disclosed herein.

The communication section 144 exchanges information with other devices.

The remote operation terminal control section 146 controls the remote operation terminal 14. For example, the remote operation terminal control section 146 controls the communication section 144 so as to acquire operation information input by the remote operator U and transmit this operation information to the server 16.

Server

As illustrated in FIG. 2, functionality of the server 16 includes a server control section 160 and a communication section 162.

The server control section 160 controls the server 16. For example, the server control section 160 controls the communication section 162 so as to acquire operation information transmitted from any remote operation terminal out of the plural remote operation terminals and transmit this operation information to the vehicle 12A.

The communication section 162 exchanges information with other devices.

Vehicle Selection Server

As illustrated in FIG. 2, functionality of the vehicle selection server 18 includes a vehicle information storage section 180, a vehicle selection server control section 182, and a communication section 184.

The vehicle information storage section 180 holds vehicle information representing each of the plural vehicles. Note that each of the vehicles for which vehicle information is held in the vehicle information storage section 180 is a vehicle planning to travel in the remote driving mode. The vehicle information includes a vehicle type, a planned travel route of the vehicle, a travel history of the vehicle, and an accident history of the vehicle.

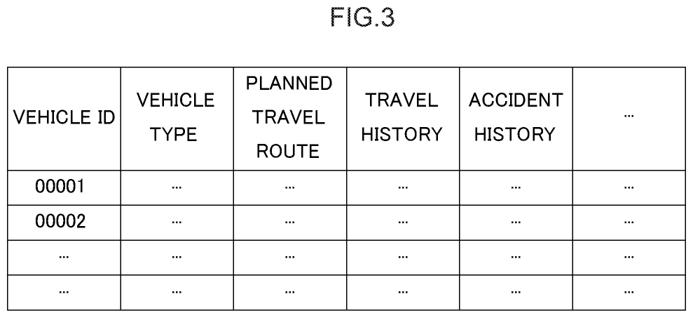

FIG. 3 illustrates an example of information held by the vehicle information storage section 180. For example, plural vehicle information items are held in a table format as illustrated in FIG. 3. In the table illustrated in FIG. 3, a vehicle ID representing identification information of a vehicle and vehicle information relating to this vehicle are held associated with each other.

The vehicle selection server control section 182 controls the vehicle selection server 18. For example, the vehicle selection server control section 182 selects a remote operation terminal from the plural remote operation terminals and controls the communication section 184 so as to transmit a remote operation terminal ID of the selected remote operation terminal to the vehicle 12A.

The communication section 184 exchanges information with other devices.

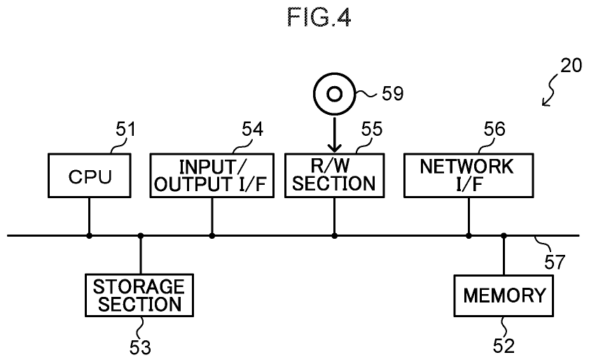

The ECU 120A of the vehicle 12A, the computer 140 of the remote operation terminal 14, the server 16, and the vehicle selection server 18 may respectively be realized by a computer 20, an example of which is illustrated in FIG. 4. The computer 20 includes a CPU 51, memory 52 serving as a temporary storage region, and a non-volatile storage section 53. The computer 20 further includes an input/output interface (I/F) 54 to which an input/output device or the like (not illustrated in the drawings) is connected, and a read/write (R/W) section 55 that controls reading and writing of data with respect to a recording medium 59. The computer 20 also includes a network I/F 56 that is connected to a network such as the internet. The CPU 51, the memory 52, the storage section 53, the input/output I/F 54, the R/W section 55, and the network I/F 56 are connected together through a bus 57.

The storage section 53 may be realized by a hard disk drive (HDD), a solid state drive (SSD), flash memory, or the like. A program to cause the computer 20 to function is stored in the storage section 53, serving as a storage medium. The CPU 51 reads the program from the storage section 53, expands the program in the memory 52, and executes processes of the program in sequence.

Explanation follows regarding operation of the vehicle control system 10 of the present exemplary embodiment.

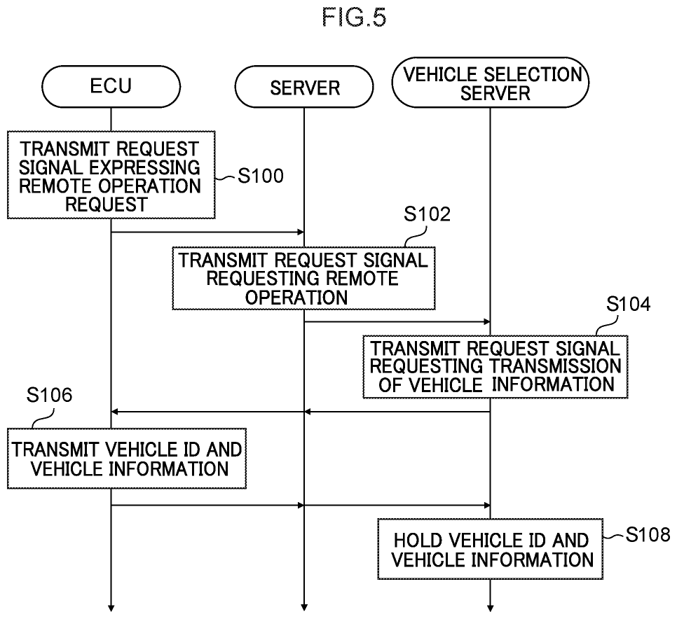

While traveling in the manual driving mode or the independent autonomous driving mode, each of the vehicles 12A, 12B, 12C executes the vehicle control sequence illustrated in FIG. 5 when switching to travel in the remote driving mode.

Note that although the vehicle control sequence illustrated in FIG. 5 is processing performed by the ECU 120A of the vehicle 12A, other vehicles (for example the vehicle 12B and the vehicle 12C) planning to travel using the remote driving mode also execute similar processing to that of the vehicle control sequence illustrated in FIG. 5.

At step S100, the vehicle control section 126A of the ECU 120A of the vehicle 12A transmits the vehicle ID of the vehicle 12A and a request signal requesting travel in the remote driving mode to the server 16 through the communication section 124A.

At step S102, the communication section 162 of the server 16 receives the vehicle ID and the request signal transmitted from the ECU 120A of the vehicle 12A. The server control section 160 of the server 16 then transmits a request signal requesting remote operation to the vehicle selection server 18 through the communication section 162.

At step S104, the communication section 184 of the vehicle selection server 18 receives the request signal transmitted from the server 16. The vehicle selection server control section 182 of the vehicle selection server 18 then transmits a request signal requesting transmission of the vehicle information of the vehicle 12A to the ECU 120A of the vehicle 12A planning to travel in the remote driving mode.

At step S106, the communication section 124A of the ECU 120A of the vehicle 12A receives the request signal transmitted from the vehicle selection server 18. The vehicle control section 126A of the ECU 120A then reads the vehicle information representing the vehicle 12A and the vehicle ID of the vehicle 12A from a predetermined storage region (not illustrated in the drawings). Note that the vehicle information includes the type of the vehicle 12A (such as small vehicle, standard vehicle, medium-heavy vehicle, or heavy vehicle), a planned travel route to a destination, a travel history, and information relating to accident history. The vehicle control section 126A of the ECU 120A then transmits the read vehicle ID and vehicle information of the vehicle 12A to the vehicle selection server 18.

The vehicle information may include other information. For example, more specific information (such as the vehicle manufacturer and the specific model name of the vehicle) may be included as the vehicle type. Information different to the vehicle information may also be included.

At step S108, the communication section 184 of the vehicle selection server 18 receives the vehicle ID and the vehicle information transmitted from the ECU 120A of the vehicle 12A. The vehicle selection server control section 182 of the vehicle selection server 18 then holds the vehicle ID and the vehicle information in the vehicle information storage section 180.

The processing of step S100 to step S108 is executed each time a vehicle planning to travel in the remote driving mode appears. The vehicle information of vehicles planning to travel in the remote driving mode is thus successively held in the vehicle information storage section 180 of the vehicle selection server 18.

Explanation follows regarding vehicle selection processing by the remote operator U.

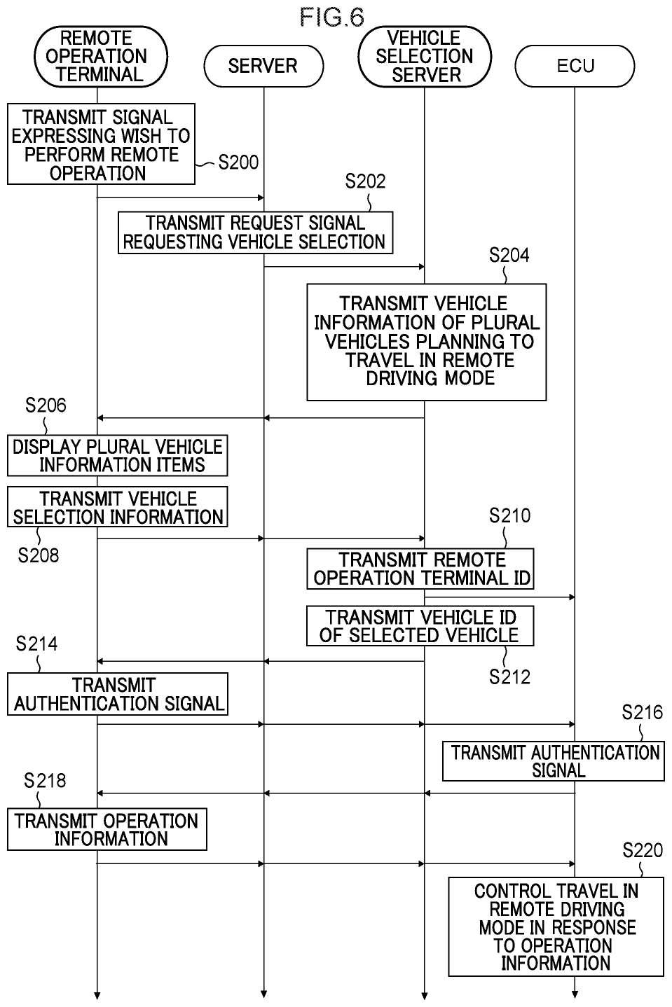

A vehicle selection sequence, illustrated in FIG. 6, is executed when a remote operation terminal of a remote operator U wishing to remotely operate a vehicle logs into the vehicle control system 10 and information expressing a wish to remotely operate a vehicle to is input the remote operation terminal 14.

The vehicle selection sequence illustrated in FIG. 6 is processing in which the remote operator U operating the remote operation terminal 14 selects a vehicle that plans to travel in the remote driving mode.

At step S200, the remote operation terminal control section 146 of the remote operation terminal 14 transmits a signal expressing a wish to perform remote operation to the server 16 through the communication section 144.

At step S202, the communication section 162 of the server 16 receives the signal transmitted from the remote operation terminal 14. The server control section 160 of the server 16 then transmits a request signal requesting that selection of a remote operation target vehicle be performed by the remote operation terminal 14 to the vehicle selection server 18 through the communication section 162.

At step S204, the communication section 184 of the vehicle selection server 18 receives the request signal transmitted from the server 16. The vehicle selection server control section 182 of the vehicle selection server 18 then refers to the vehicle information storage section 180 and transmits the vehicle information regarding each of plural vehicles that plan to travel in the remote driving mode to the remote operation terminal 14.

At step S206, the communication section 144 of the remote operation terminal 14 receives the vehicle information regarding each of the plural vehicles that plan to travel in the remote driving mode transmitted from the vehicle selection server 18. The remote operation terminal control section 146 of the remote operation terminal 14 then displays the plural vehicle information items on the display device 142.

The remote operator U operating the remote operation terminal 14 checks the plural vehicle information items displayed on the display device 142, and decides which of the vehicles to remotely operate. For example, the remote operator U may refer to the planned travel routes and select a vehicle with a planned travel route that the remote operator U believes will allow easy remote operation as the remote operation target vehicle. Alternatively, for example the remote operator U may refer to the vehicle types and select a vehicle of a type that the remote operator U believes be easy for them to remotely operate.

The remote operator U at the remote operation terminal 14 inputs selection information regarding one of the remote operation target vehicles to the remote operation terminal 14.

At step S208, the remote operation terminal control section 146 of the remote operation terminal 14 acquires the vehicle selection information input by the remote operator U. The remote operation terminal control section 146 of the remote operation terminal 14 then transmits the vehicle selection information and a remote operation terminal ID to the vehicle selection server 18 through the communication section 144.

At step S210, the communication section 184 of the vehicle selection server 18 receives the vehicle selection information and the remote operation terminal ID transmitted from the remote operation terminal 14. The vehicle selection server control section 182 of the vehicle selection server 18 then transmits the received remote operation terminal ID to the ECU of the vehicle corresponding to the selection information. Note in the example described here, the vehicle 12A is the vehicle corresponding to the selection information. Accordingly, the vehicle selection server control section 182 of the vehicle selection server 18 transmits the received remote operation terminal ID to the ECU 120A of the vehicle 12A corresponding to the selection information. The remote operation terminal ID is an example of remote operation terminal identification information of the technology disclosed herein.

The communication section 124A of the ECU 120A of the vehicle 12A receives the remote operation terminal ID transmitted from the vehicle selection server 18. The ECU 120A of the vehicle 12A checks that remote operation is being performed by the remote operation terminal 14 corresponding to the remote operation terminal ID transmitted from the vehicle selection server 18.

At step S212, the vehicle selection server control section 182 of the vehicle selection server 18 transmits the vehicle ID of the remote operation target vehicle to the remote operation terminal 14.

At step S214, the remote operation terminal control section 146 of the remote operation terminal 14 transmits an authentication signal to the ECU 120A in order to perform authentication between itself and the ECU 120A of the vehicle 12A.

At step S216, on receiving the authentication signal transmitted from the remote operation terminal 14, the vehicle control section 126A of the ECU 120A of the vehicle 12A transmits an authentication signal to the remote operation terminal 14.

Authentication between the ECU 120A and the remote operation terminal 14 is completed by performing the processing of step S214 and step S216, thereby establishing a match between the vehicle 12A and the remote operator U at the remote operation terminal 14. Remote operation of the vehicle 12A by the remote operation terminal 14 is started in this manner.

At step S218, the remote operator U of the remote operation terminal 14 inputs operation information for the vehicle 12A into the remote operation terminal 14. The remote operation terminal 14 then transmits this operation information to the ECU 120A.

At step S220, the ECU 120A of the vehicle 12A receives the operation information transmitted from the remote operation terminal 14 and controls travel of the vehicle 12A in the remote driving mode in response to the operation information.

The processing of step S218 and the processing of step S220 are repeated until travel of the vehicle 12A in the remote driving mode ends.

As described above, the vehicle control system 10 according to the present exemplary embodiment includes the vehicle selection server, the vehicle control device that controls the vehicle capable of traveling in the independent autonomous driving mode, the remote driving mode, and the manual driving mode, and the remote operation terminal that operates the vehicle remotely. The vehicle selection server refers to the vehicle information storage section that holds vehicle information representing each of plural vehicles, and transmits the vehicle information regarding each of the plural vehicles to the remote operation terminal. The remote operation terminal displays the vehicle information regarding the plural vehicles on the display device, acquires the vehicle selection information input by the remote operator, and transmits the selection information to the vehicle selection server. The vehicle selection server then transmits the remote operation terminal ID of the remote operation terminal that output the selection information to the ECU of the vehicle corresponding to the selection information. The ECU of the corresponding vehicle then performs control in response to vehicle operation information transmitted from the remote operation terminal corresponding to the remote operation terminal ID so as to cause the vehicle to travel in the remote driving mode. This enables the remote operator to select a remote operation target vehicle as a vehicle the remote operator causes to travel in the remote driving mode. Accordingly, remote operation of the vehicle is performed by the remote operator in an appropriate manner.

Note that although explanation has been given in which the processing performed by the respective devices of the exemplary embodiment described above is implemented by software processing by executing a program, processing may be performed using hardware. Alternatively, processing may be performed using a combination of both software and hardware. Alternatively, a program stored in the ROM may be distributed stored on storage media of various types.

The technology disclosed herein is not limited to that described above, and obviously various other modifications may be implemented within a range not departing from the spirit of the technology disclosed herein.

For example, although explanation has been given regarding an example of remote operation of a vehicle selected by the remote operator U in the exemplary embodiment described above, there is no limitation thereto. For example, configuration may be made in which the ECU of a vehicle transmits condition information relating to a remote operator U input by an occupant of the vehicle to the vehicle selection server, and the vehicle selection server transmits the vehicle information of the vehicle with the ECU that sent the condition information to a remote operation terminal corresponding to a remote operator U satisfying the condition information. An example of the condition information is information relating to the remote operation experience of the remote operator. More specifically, examples of the condition information include information expressing a condition of experience in remote operation of vehicles of the same type as the vehicle in question, information expressing a condition of experience in remote operation of vehicles on the planned travel route of the vehicle in question, and information expressing a condition of there being no history of accidents during remote operation.

An object of the technology disclosed herein is to provide a vehicle control system and a vehicle control method that enable a remote operator to select a remote operation target vehicle as a vehicle the remote operator causes to travel in a remote driving mode.

A vehicle control system according to a first aspect includes a vehicle selection server, a vehicle control device configured to control a vehicle capable of traveling in an independent autonomous driving mode, a remote driving mode, and a manual driving mode, and a remote operation terminal configured to operate a vehicle remotely. The vehicle selection server is configured to refer to a vehicle information storage section holding vehicle information representing each of plural vehicles, and to transmit the vehicle information regarding each of the plural vehicles to the remote operation terminal. The remote operation terminal is configured to display the vehicle information regarding the plural vehicles on a display section, to acquire selection information for one of the vehicles input by a remote operator, and to transmit the selection information to the vehicle selection server. The vehicle selection server is configured to transmit identification information regarding the remote operation terminal that output the selection information to the vehicle control device of the vehicle corresponding to the selection information. The vehicle control device is configured to perform control in response to vehicle operation information transmitted from the remote operation terminal corresponding to the identification information so as to cause the vehicle to travel in the remote driving mode.

The vehicle selection server of the vehicle control system according to the first aspect refers to the vehicle information storage section holding the vehicle information representing each of the plural vehicles, and transmits the vehicle information regarding each of the plural vehicles to the remote operation terminal. The remote operation terminal displays the vehicle information regarding the plural vehicles on the display section, acquires selection information for one of the vehicles input by the remote operator, and transmits this selection information to the vehicle selection server. The vehicle selection server transmits the identification information regarding the remote operation terminal that output the selection information to the vehicle control device of the vehicle corresponding to the selection information. The vehicle control device performs control in response to the vehicle operation information transmitted from the remote operation terminal corresponding to the identification information so as to cause the vehicle to travel in the remote driving mode. This enables the remote operator to select a remote operation target vehicle as a vehicle the remote operator causes to travel in the remote driving mode. The remote operator is thus able to perform remote operation of a desired vehicle.

Note that the driving modes refer to types of travel control of the vehicle, and include the independent autonomous driving mode, the remote driving mode, and the manual driving mode. The independent autonomous driving mode is a driving mode in which the vehicle travels independently based on information successively detected by various sensors provided to the vehicle. The remote driving mode is a driving mode in which the vehicle travels based on operation information output from the remote operation terminal. The manual driving mode is a driving mode in which the vehicle travels by being driven by an occupant on board the vehicle. The vehicle information is information representing the vehicle, and may include a vehicle type, a planned travel route of the vehicle, a travel history of the vehicle, and an accident history of the vehicle.

In a vehicle control system according to a second aspect, the vehicle control device is configured to transmit condition information relating to a remote operator input by an occupant of the vehicle to the vehicle selection server, and the vehicle selection server is configured to transmit the vehicle information of the vehicle with the vehicle control device that sent the condition information to a remote operation terminal corresponding to a remote operator satisfying the condition information.

The condition information relating to the remote operator is for example information set by the occupant of the vehicle. An example of the condition information is information relating to the remote operation experience of the remote operator.

In a vehicle control system according to a third aspect, the vehicle information includes at least one out of vehicle type, planned route of vehicle travel, vehicle travel history, and vehicle accident history.

A vehicle control method according to a fourth aspect is a vehicle control method for a vehicle control system including a vehicle selection server, a vehicle control device configured to control a vehicle capable of traveling in an independent autonomous driving mode, a remote driving mode, and a manual driving mode, and a remote operation terminal configured to operate a vehicle remotely. In this method, the vehicle selection server refers to a vehicle information storage section holding vehicle information representing each of plural vehicles, and transmits the vehicle information regarding each of the plural vehicles to the remote operation terminal. The remote operation terminal displays the vehicle information regarding the plural vehicles on a display section, acquires selection information for one of the vehicles input by a remote operator, and transmits the selection information to the vehicle selection server. The vehicle selection server transmits identification information regarding the remote operation terminal that output the selection information to the vehicle control device of the vehicle corresponding to the selection information. The vehicle control device performs control in response to vehicle operation information transmitted from the remote operation terminal corresponding to the identification information so as to cause the vehicle to travel in the remote driving mode.

The technology described above exhibits the advantageous effect of enabling a remote operator to select a remote operation target vehicle as a vehicle the remote operator causes to travel in a remote driving mode.

The disclosures of Japanese Patent Application No. 2019-135243, filed on Jul. 23, 2019 are incorporated herein by reference in their entirety.

All publications, patent applications, and technical standards mentioned in this specification are herein incorporated by reference to the same extent as if each individual publication, patent application, or technical standard was specifically and individually indicated to be incorporated by reference.

1. A vehicle control system comprising:
a vehicle selection server comprising;
a first memory, and
a first processor coupled to the first memory;
a vehicle control device comprising;
a second memory, and
a second processor coupled to the second memory, the second processor being configured to:
control a host vehicle capable of traveling in an autonomous self-driving mode, a remote driving mode, and a manual driving mode; and
a remote operation terminal comprising;
a third memory, and
a third processor coupled to the third memory, the third processor being configured to:
operate the host vehicle remotely,
wherein the first processor is configured to refer to the first memory, which stores vehicle information representing each of a plurality of vehicles, and to transmit the vehicle information regarding each of the plurality of vehicles to the third processor;
wherein the third processor is configured to display the vehicle information regarding each of the plurality of vehicles on a display section, to acquire selection information, input by a remote operator, for one of the plurality of vehicles, and to transmit the selection information to the first processor;
wherein the first processor is configured to transmit identification information regarding the third processor that output the selection information to the second processor of the one of the plurality of vehicles corresponding to the selection information; and
wherein the second processor is configured to perform control in response to vehicle operation information transmitted from the third processor corresponding to the identification information so as to cause the host vehicle to travel in the remote driving mode.

2. The vehicle control system of claim 1, wherein:
the second processor is configured to transmit condition information, relating to the remote operator, input by an occupant of the host vehicle to the first processor; and
the first processor is configured to transmit the vehicle information of the vehicle with the second processor that sent the condition information to the third processor corresponding to the remote operator satisfying the condition information.

3. The vehicle control system of either claim 1, wherein the vehicle information includes at least one of vehicle type, planned route of vehicle travel, vehicle travel history, or vehicle accident history.

4. The vehicle control system of either claim 2, wherein the vehicle information includes at least one of vehicle type, planned route of vehicle travel, vehicle travel history, or vehicle accident history.

5. A vehicle control method for a vehicle control system comprising:
a vehicle selection server comprising;
a first memory, and
a first processor coupled to the first memory;
a vehicle control device comprising;
a second memory, and
a second processor coupled to the second memory, the second processor being configured to:
control a host vehicle capable of traveling in an autonomous self-driving mode, a remote driving mode, and a manual driving mode; and
a remote operation terminal comprising;
a third memory, and
a third processor coupled to the third memory, the third processor being configured to:
operate the host vehicle remotely, wherein the method comprises:
the first processor referring to the first memory, which stores vehicle information representing each of a plurality of vehicles, and transmitting the vehicle information regarding each of the plurality of vehicles to the third processor,
the third processor displaying the vehicle information regarding each of the plurality of vehicles on a display section, to acquire selection information, input by a remote operator, for one of the plurality of vehicles, and transmitting the selection information to the first processor,
the first processor transmitting identification information regarding the third processor that output the selection information to the second processor of the one of the plurality of vehicles corresponding to the selection information, and
the second processor performing control in response to vehicle operation information transmitted from the third processor corresponding to the identification information so as to cause the host vehicle to travel in the remote driving mode.
